(19) United States
(12) Patent Application Publication
(10) Pub. No.: US 2026/0211752 A1
(43) Pub. Date: Jul. 23, 2026

(54) METHODS OF OPERATING A CONFIGURABLE DATA PIPELINE AND RELATED COMPUTING SYSTEMS AND COMPUTER-READABLE MEDIA

(71) Applicant: CDK GLOBAL, LLC, Austin, TX (US)

(72) Inventors: Marc Von Ahn, West Linn, OR (US); Mahesh Shanmugasundaram, Austin, TX (US)

(21) Appl. No.: 19/035,590

(22) Filed: Jan. 23, 2025

(51) Int. Cl. G06F 9/54

(52) U.S. Cl. CPC G06F 9/542

(57) ABSTRACT

Configurable data pipelines and related methods and computer-readable media are disclosed. A method includes pushing new event data for a new event received through a first one of a plurality of different communication channels from a source software application to an event bus. The plurality of different communication channels communicate with a plurality of different data ingestion/consumption systems operate according to different protocols to receive event data corresponding to events from source software applications executed by client devices. The method also includes routing the new event data to a destination software application through a second one of the plurality of different communication channels based, at least in part, on routing rules from a rules database. The rules database includes routing data indicating the routing rules for how the events should be routed through the plurality of different communication channels to destination software applications.

### TECHNICAL FIELD

This disclosure relates generally to methods of operating a configurable data pipeline and related computing systems and computer-readable media. More particularly, the disclosure may relate to configurable data pipelines that may be used in a digital retail ecosystem (e.g., for vehicle dealerships or otherwise) including legacy, modern, and transitioning systems.

### BACKGROUND

Software applications of various forms are proliferating in a variety of different environments. In digital retail ecosystems, data may be gathered by different software applications.

### BRIEF SUMMARY

In some embodiments, a configurable data pipeline includes one or more processors and one or more data storage devices operably coupled to the one or more processors. The one or more data storage devices have computer-readable instructions stored thereon. The computer-readable instructions are configured to instruct the one or more processors to maintain a plurality of different communication channels to a plurality of different data ingestion systems operating according to different protocols to receive event data corresponding to events from source software applications executed by client devices and route the event data to destination software applications executed by the client devices. The computer-readable instructions are also configured to instruct the one or more processors to maintain a rules database on the one or more data storage devices. The rules database includes routing data indicating routing rules for how the events received from the source software applications should be routed through the plurality of different communication channels to the destination software applications. The computer-readable instructions are further configured to instruct the one or more processors to push new event data for a new event received through a first one of the plurality of different communication channels from a source software application to an event bus and route the new event data to a destination software application through a second one of the plurality of different communication channels based, at least in part, on the routing rules from the rules database.

In some embodiments, a method of operating a configurable data pipeline includes pushing new event data for a new event received through a first one of a plurality of different communication channels from a source software application to the configurable data pipeline. The plurality of different communication channels communicate with a plurality of different data ingestion systems operating according to different protocols to receive event data corresponding to events from source software applications executed by client devices. The method also includes routing the new event data to a destination software application through a second one of the plurality of different communication channels based, at least in part, on routing rules from a rules database. The rules database includes routing data indicating the routing rules for how the events received from the source software applications should be routed through the plurality of different communication channels to destination software applications.

In some embodiments, one or more computer-readable media include computer-readable instructions stored thereon. The computer-readable instructions are configured to instruct one or more processors to push new event data for a new event received through a first one of a plurality of different communication channels from a source software application to a configurable data pipeline. The plurality of different communication channels communicate with a plurality of different data ingestion systems operating according to different protocols to receive event data corresponding to events from source software applications executed by client devices. The computer-readable instructions are also configured to instruct the one or more processors to route the new event data to a destination software application through a second one of the plurality of different communication channels based, at least in part, on routing rules from a rules database. The rules database includes routing data indicating the routing rules for how the events received from the software applications should be routed through the plurality of different communication channels to destination software applications.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a block diagram of a computing system, according to some embodiments;

FIG. 2 is a block diagram of an example of a configurable data pipeline, according to some embodiments;

FIG. 3 is a flowchart illustrating a method of operating a configurable data pipeline (e.g., the configurable data pipeline of FIG. 1 and FIG. 2), according to some embodiments; and

FIG. 4 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms "exemplary," "by example," and "for example," means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general‑purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as "first," "second," and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, the term “real-time,” in the context of processing and transmitting data, refers to transmission of data as it is generated, with the understanding that processing and transmitting data inherently involves delays from immediate delivery of data (e.g., processing and transmission delays).

As used herein, the term “serverless” refers to a feature of a cloud computing system wherein a cloud provider automatically manages infrastructure for running applications (e.g., provisioning, scaling, maintenance, and availability).

A digital retail environment may be a mix of legacy and modernized software applications. For example, a vehicle dealership digital retail environment may include customer relationship management (CRM) software applications, inventory management software applications, finance and insurance (F&I) software applications, document management software applications, and customer-facing retail platform software applications. Effective communication and data sharing between these software applications may enable avoidance of redundant data entry, reduce operational friction, and increase the likelihood of a seamless user experience. Embodiments disclosed herein may avoid relying on an integration that is rigid, resource-intensive, and ill-equipped to handle the diverse and evolving needs of such ecosystems, particularly when dealing with the complexities of transitioning from legacy to modern software applications.

Some embodiments disclosed herein include a serverless enterprise data pipeline platform designed to integrate diverse applications within the digital retail ecosystem, including legacy, modern, and transitioning systems. The platform supports seamless data exchange and processing, reducing redundancy, reducing friction, and enhancing the user experience. Some embodiments disclosed herein may include configurable event onboarding, flexible data ingestion, configurable data transformation templates (including transformations between legacy and modern applications), filtering and enrichment mechanisms, and rule-based routing to various data consumers. This platform streamlines workflows, improves data integrity, and enables seamless integration across disparate systems (e.g., within digital retail).

In various embodiments, a flexible, scalable, and cost-efficient solution for integrating diverse software applications within a digital retail ecosystem is proposed. Some embodiments disclosed herein include a serverless enterprise data pipeline platform, offering configurable event onboarding, data transformation (including legacy-to-modern transformations), filtering, enrichment, and rule-based event routing. The platform is configured to ingest data from various sources, including streaming technologies, HTTP services, WebSockets, and serverless functions, and route this data to multiple consumers. The platform uses configurable templates that support data transformation between legacy and modern applications, ensuring compatibility across disparate systems. The platform uses configurable filtering and enrichment mechanisms to tailor data processing to specific application requirements. The platform includes a rule-based engine for flexible event routing, enabling precise control over data distribution to various consumers. The platform provides support for multiple data consumption methods, allowing seamless integration with streaming services, batch processing systems, HTTP endpoints, and WebSocket clients.

Configurable serverless enterprise data pipeline platforms according to embodiments disclosed herein may provide a flexible, scalable, and efficient means of data exchange and processing, with the ability to transform data between legacy and modern systems. Embodiments disclosed herein may enhance workflow efficiency, reduce friction, and improve data integrity across the digital retail sector.

In the specific, non-limiting example of a vehicle dealership environment, configurable data pipelines according to embodiments disclosed herein may be used to enable sharing of information between different, otherwise disparate software applications. For example, an interested vehicle shopper may access a CRM software application to shop for vehicles online. The CRM software application may receive inputs from the vehicle shopper identifying the vehicle shopper (e.g., name and contact information such as email address, telephone number, residential address, etc.) and a vehicle the vehicle shopper is interested in buying. The CRM software application may deliver this received information to the configurable data pipeline (e.g., via a data ingestion system conforming to an event architecture), and the information may be pushed as an event to the configurable data pipeline. The configurable data pipeline may route the information to other software applications via data consumption systems. For example, the information may be delivered to an inventory management software application, a finance and insurance software application, and a documents management software application to avoid the need for the same information to be input into these other software applications manually. As a result, redundant data entry in different software applications may be reduced.

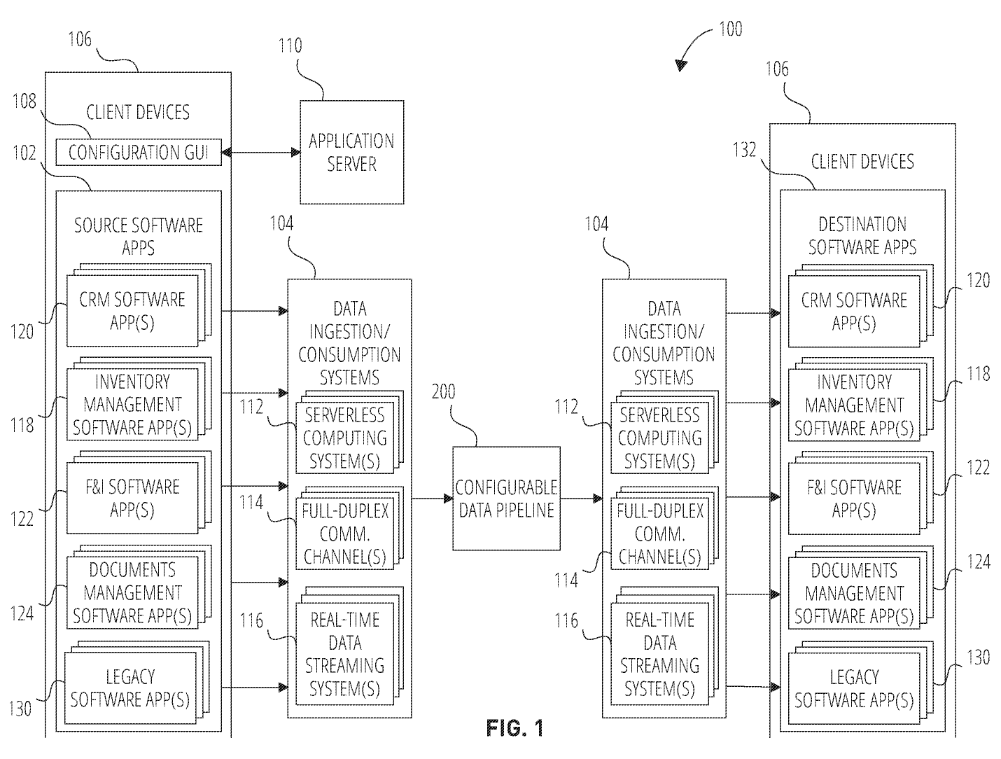

FIG. 1 is a block diagram of a computing system 100, according to some embodiments. The computing system 100 includes a configurable data pipeline 200, a plurality of client devices 106, a plurality of different data ingestion/consumption systems 104, and an application server 110. The plurality of client devices 106 may include computers, tablet computers, mobile devices (e.g., smart phones), point of sale devices, other devices, or combinations thereof. The plurality of client devices 106 is configured to execute source software applications 102 and destination software applications 132 that provide and receive, respectively, information to and from the configurable data pipeline 200 through the data ingestion/consumption systems 104. As used herein, the terms “source software applications” and “destination software applications” do not necessarily imply that software applications identified with the “source software application” category are excluded from the category identified with “destination software application.” Rather, in one instance, a specific software application may function as a source software application to provide data (e.g., event data) and in another instance, the same software application may function as a destination software application that receives data (e.g., event data). There may even be some instances in which a specific software application functions both as a source software application and a destination software application.

The source software applications 102 and the destination software applications 132 may include various different software applications. As a specific, non-limiting example, the computing system 100 may include a vehicle dealership enterprise ecosystem wherein the source software applications 102 and the destination software applications 132 executed by the client devices 106 include vehicle dealership software applications. For example, the source software applications 102 and the destination software applications 132 may include one or more CRM software applications 120, one or more inventory management software applications 118, one or more finance and insurance software applications 122, one or more documents management software applications 124, one or more legacy software apps 130, other software applications, or combinations thereof.

By way of non-limiting example, the CRM software applications 120 may be configured to customize and automate interactions with customers. For example, the CRM software applications 120 may be configured to perform lead management (e.g., capture, track, store leads, etc.), manage customer interaction (e.g., communication logging, automated follow-ups, schedule appointments, etc.), manage the sales process (e.g., sales funnel tracking, task management, quote and deal management, etc.), automate marketing (e.g., email campaigns, customer segmentation, campaign performance tracking, etc.), manage customer retention and service (e.g., service reminders, customer feedback and surveys, loyalty programs, etc.), manage analytics and reporting (e.g., sales performance, customer insights, forecasting, etc.), perform other customer relations functions, or combinations thereof.

By way of non-limiting example, the inventory management software applications 118 may be configured to manage vehicle inventory for vehicle dealerships. For example, inventory management software applications 118 may be configured to track and organize vehicles (e.g., stock monitoring, vehicle identification number (VIN) decoding, lot location tracking, condition and status updates, etc.), assist in pricing and appraisal (e.g., automated pricing, price adjustments, trade-in appraisal, etc.), automate and report inventory (e.g., turnover analysis, stocking recommendation, sales and inventory reports, etc.), integrate digital marketing (e.g., online listings, search engine optimization (SEO), lead generation, etc.), acquisition and sourcing (e.g., auction integration, supplier and dealer network integration, etc.), manage photos and descriptions (e.g., vehicle photos, automated descriptions, etc.), integrate with dealership management system (e.g., data synchronization, order management, etc.), other inventory management functions, or combinations thereof.

By way of non-limiting example, the finance and insurance software applications 122 may be configured to automate, streamline, and/or manage finance and insurance aspects of vehicle sales. For example, the finance and insurance software applications 122 may be configured to manage a loan and/or lease (e.g., financing options, credit checks, payment calculation, etc.), present F&I options (e.g., product presentation, customization, etc.), manage compliance documentation (e.g., regulatory compliance, electronic contracting, document storage, etc.), manage sale of insurance (e.g., insurance product integration, quoting and comparison, etc.), manage reporting and analytics (e.g., performance tracking, sales analysis, compliance audits, etc.), manage customer relations (e.g., follow-up scheduling, customer information storage, etc.), other F&I functions, or combinations thereof.

By way of non-limiting example, the documents management software applications 124 may be configured to organize, store, and streamline access to documents involved in sales, service, and/or administration of a vehicle dealership. For example, the documents management software applications 124 may be configured to store digital documents (e.g., centralized repository, document categorization, version control, etc.), create and edit documents (e.g., templates and forms, electronic signatures, auto-fill features, etc.), manage compliance and security (e.g., regulatory compliance, access control, audit trails, etc.), retrieve and search documents (e.g., advanced search, quick retrieval, etc.), integrate with dealership systems (e.g., CRM and dealership management systems (DMSs), F&I system integration, etc.), automate workflow (e.g., approval processes, notifications and reminders, etc.), manage customer documents (e.g., digital delivery, customer portal, etc.), generating reports and analytics (e.g., document usage reports, compliance reporting, etc.), or combinations thereof.

The legacy software apps 130 may include software applications from any of the other above-discussed categories or may be from different categories not discussed above (e.g., customer-facing retail platform software applications). In some examples, the legacy software apps 130 may include out-of-date software applications. The configurable data pipeline 200 includes specific functionality to support the transformation of data between legacy and modern applications. This includes mapping outdated data formats, converting legacy data structures, and applying modern data standards, enabling compatibility across different systems within the computing system 100 (e.g., a digital retail ecosystem). The configurable data pipeline 200 provides customizable templates for data transformation, supporting both straightforward and complex data processing requirements. The configurable data pipeline 200 includes specialized transformation capabilities for converting data formats and structures between legacy and modern applications. This ensures that data originating from legacy systems can be seamlessly integrated into modern applications, and vice versa, without manual intervention.

Many of the source software applications 102 and the destination software applications 132 may not be equipped with capabilities to communicate directly with each other. It may, however, be helpful in many situations for the source software applications 102 and the destination software applications 132 to be able to communicate with each other. For example, customer and/or vehicle information provided to one of the source software applications 102 or destination software applications 132 may be useful in others of the source software applications 102 or destination software applications 132. Without some communication channel that two software application can communicate with each other through, however, communication between the software applications may not be possible. As a result, time and effort may be wasted in entering duplicative information and performing redundant processing, and other complications may arise from this lack of communication.

While in many cases, software interfaces such as application programming interfaces (APIs) may be developed to enable software applications to communicate with each other, these software interfaces may be difficult, time-consuming, and expensive to implement. Rather than focus on establishing individual software interfaces between each one of the source software applications 102 and destination software applications 132 that should communicate with each other within the computing system 100, embodiments disclosed herein leverage sometimes disparate communication capabilities the source software applications 102 and the destination software applications 132 already have to enable communication between the software applications.

The configurable data pipeline 200 supports data ingestion from a wide array of sources, including streaming technologies, HTTP services, WebSockets, and serverless functions, enabling seamless integration across various data streams. Also, the configurable data pipeline 200 supports multiple methods for data consumption, enabling integration with a variety of consumer systems. Data may be delivered in real-time via streaming services, processed in batches, consumed through HTTP endpoints, or transmitted via WebSockets.

In some embodiments, the plurality of different data ingestion/consumption systems 104 include one or more real-time data streaming systems 116, one or more full-duplex communication channels 114 over a persistent connection, one or more serverless computing systems 112, or combinations thereof. The one or more serverless computing systems 112 may be configured to automatically manage and scale compute resources (e.g., in an event-driven architecture) within an event-driven architecture. A non-limiting example of a commercially available serverless computing system 112 is Amazon Web Services (AWS) Lambda, provided by AWS, a subsidiary of Amazon.com, Inc., headquartered in Seattle, WA. Other examples of serverless computing systems 112 include Google Cloud Functions, provided by Google Cloud under the parent company Google LLC, headquartered in Sunnyvale, CA; Azure functions, provided by Microsoft Corporation, headquartered in Redmond, WA; IBM Cloud Functions, provided by International Business Machines (IBM), headquartered in Armonk, NY; and Oracle Functions, provided by Oracle Corporation, headquartered in Austin, TX, and built on Oracle's open-source Fn Project.

The one or more full-duplex communication channels 114 may be configured to provide full-duplex, two-way communication channels over a single, long-lived connection between a client (e.g., a web browser) and a server (e.g., without repeatedly opening and closing connections). A non-limiting example of an open-source full-duplex communication channel 114 is WebSockets, governed by the WebSocket protocol, an open standard developed and maintained by the Internet Engineering Task Force (IETF), and defined in RFC 6455.

The one or more real-time data streaming systems 116 may be configured to handle high-throughput, real-time data streams. A non-limiting example of a real-time data streaming system 116 is Apache Kafka, an open-source system developed by the Apache Software Foundation, based in Wakefield, MA. Another non-limiting example of a real-time data streaming system 116 is Amazon Kinesis, provided by AWS.

The configurable data pipeline 200 is configured to provide flexible, scalable, and cost-efficient solutions for integrating diverse software applications (e.g., the source software applications 102 and the data ingestion/consumption systems 104) executed by the client devices 106. For example, the configurable data pipeline 200 may be configured to integrate otherwise disparate software applications that would not otherwise be capable of communicating with each other. Specifically, each of the various software applications (e.g., the source software applications 102 and the destination software applications 132) may be configured to communicate (e.g., via events) with the configurable data pipeline 200 through one or more of the data ingestion/consumption systems 104. The configurable data pipeline 200 may push communications (e.g., events) received from source software applications 102 via the data ingestion/consumption systems 104 to destination software applications 132. Accordingly, regardless of which of the data ingestion/consumption systems 104 a given software application is capable of communicating through, the configurable data pipeline 200 may enable the software application to communicate with any other software application capable of communicating via one of the data ingestion/consumption systems 104 with the configurable data pipeline 200.

The application server 110 is configured to provide a configuration graphical user interface 108 (configuration GUI 108) to the client devices 106. In some embodiments, the configuration GUI 108 may be provided by a web application. In some embodiments, the configuration GUI 108 may instead be provided by a software application. The configuration GUI 108 may be configured to enable configurable event onboarding. For example, the configuration GUI 108 may be configured to enable a user at one of the client devices 106 configure rules used by the configurable data pipeline 200 to route events to one or more of the destination software applications 132. Also by way of non-limiting example, a user-friendly configuration GUI 108 enables the rapid onboarding of new events, allowing users to define event types, sources, and metadata for quick integration into existing workflows.

By enabling seamless data flow between legacy and modern systems, the configurable data pipeline 200 reduces the need for manual data entry and transfer, improves operational efficiency, and enhances the overall user experience across the computing system 100 (e.g., a digital retail environment).

The configurable data pipeline 200 also provides robust observability and auditing capabilities. A dashboard (e.g., at the configuration GUI 108) tracks the event injection, lag, and consumption to provide clear metrics and quick enable users to quickly identify and debug any issues. By way of non-limiting example, the configurable data pipeline 200 may track the number of events delivered thereto and the number of events delivered to the destination software applications 132. The configurable data pipeline 200 may also track the lag. The configurable data pipeline 200 may report these tracked parameters to the dashboard.

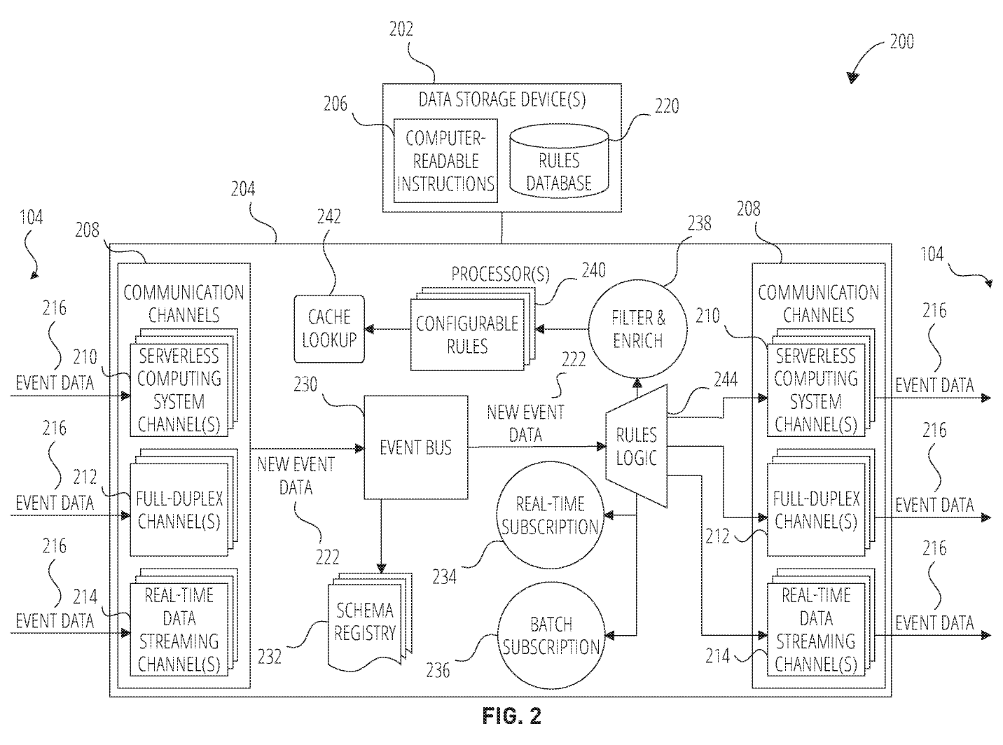

FIG. 2 is a block diagram of an example of a configurable data pipeline 200, according to some embodiments. The configurable data pipeline 200 includes one or more processors 204 and one or more data storage devices 202 operably coupled to the one or more processors 204. The computer-readable instructions 206 are configured to instruct the one or more processors 204 to maintain a plurality of different communication channels 208 to the plurality of different data ingestion/consumption systems 104 (FIG. 1) operating according to different protocols to receive event data 216 corresponding to events from the source software applications 102 (FIG. 1) executed by the client devices 106 (FIG. 1) and route the event data 216 to the destination software applications 132 executed by the client devices 106. In some embodiments, an event may represent a state change to a piece of information within the computing system 100.

The computer-readable instructions 206 are also configured to instruct the processors 204 to maintain a rules database 220 on the one or more data storage devices 202. The rules database 220 includes routing data indicating routing rules for how the events received from the source software applications 102 (FIG. 1) should be routed through the plurality of different communication channels 208 to specific destination software applications 132 (FIG. 1). By way of non-limiting example, a rule stored in the rules database 220 may direct

The computer-readable instructions 206 are further configured to instruct the one or more processors 204 to push new event data 222 for a new event received through a first one of the plurality of different communication channels 208 from a source software application (e.g., one of the source software applications 102 of FIG. 1) to an event bus 126. The event bus 126 is a data pipeline where the event data 216 received through the communication channels 208 is published. The computer-readable instructions 206 are configured to instruct the processors 204 to maintain a schema registry 232 to register events received via the communication channels 208 and published to the event bus 230. The schema registry 232 stores records of events pushed to the event bus 230. In some embodiments, the schema registry 232 may be stored locally at the processors 204. In some embodiments, the schema registry 232 may be stored at the data storage devices 202.

The computer-readable instructions 206 are configured to instruct the one or more processors 204 to route the new event data 222 to a destination software application (e.g., one of the destination software applications 132 of FIG. 1) through a second one of the plurality of different communication channels 208 based, at least in part, on the routing rules from the rules database 220. Rules logic 134 conforming to the rules in the rules database 220 may be used to route the new event data 222 to the appropriate one of the destination software applications 132 (FIG. 1) through the appropriate one of the communication channels 208 and the corresponding one of the data ingestion/consumption systems 104. The rules logic 134 may access configurable rules 240 from the rules database 220 and use the configurable rules 240 to make decisions on how to route new event data 222 received through the communication channels 208. In some embodiments, the configurable rules 240 may be stored in a cache lookup 242 for quick access by the processors 204.

In some embodiments, the rules may specify modes of routing event data 216 to destination software applications 132. The modes of routing are configurable by users of the client devices 106 (FIG. 1) (e.g., using the configuration GUI 108). By way of non-limiting example, the modes of routing may include real-time routing and batch routing. Real-time routing may involve routing of event data 216 to destination software applications 132 in real-time as it is received from source software applications 102. Users of the client devices 106 (FIG. 1) may subscribe to a real-time subscription 234 to receive event data 216 in real-time. Batch routing may involve periodic (e.g., scheduled periodic) delivery of event data 216 (e.g., once every hour, once every day, etc.). Users of the client devices 106 may subscribe to a batch subscription 236 to receive event data 216 in batches.

The configurable data pipeline 200 may include filter and enrichment mechanisms 238. The filter and enrichment mechanisms 238 tailor data processing to specific application requirements. In some embodiments, the rules database 220 includes filter rules specifying sub-portions of received event data 216 that are to be routed. For example, in some instances, only portions of the event data 216 from one software application would be useful to another software application. Accordingly, the filter and enrichment mechanisms 238 enable the configurable data pipeline 200 to pick and choose portions of the event data 216 to route to specific destination software applications 132 according to the filter rules in the rules database 220. The configuration GUI 108 (FIG. 1) may be configured to enable users of the client devices 106 to configure the filter rules. The computer-readable instructions 206 are configured to instruct the one or more processors 204 to route the new event data 222 based, at least in part, on the filter rules stored in the rules database 220. Accordingly, users of the client devices 106 (FIG. 1) may apply configurable filters to select relevant data before it is routed to consumers (e.g., the destination software applications 132 via the data ingestion/consumption systems 104).

The filter and enrichment mechanisms 238 also enable enriching the event data 216 before routing it to the destination software applications 132 (FIG. 1). The rules database 220 includes enrichment rules specifying supplemental information to be routed to the destination software applications 132 (FIG. 1) with the event data 216. Also, external data sources (e.g., performing real-time calculations or appending supplementary information) may be used to add additional value or context to the event data 216 before routing it to consumers. The computer-readable instructions are further configured to instruct the one or more processors to route the new event data based, at least in part, on the enrichment rules. The configuration GUI 108 (FIG. 1) may be configured to enable users of the client devices 106 to configure the enrichment rules. Accordingly, users of the client devices 106 (FIG. 1) may apply configurable enrichment mechanisms to select relevant data before it is routed to consumers.

A sophisticated rule-based engine allows users to define conditions (e.g., using the configuration GUI 108 at the client devices 106 of FIG. 1) for how and where event data 216 should be routed based on attributes such as event type, source, or content. This increases the chances that data is delivered to the correct consumers in the appropriate format and at the right time.

In some embodiments, the configurable data pipeline 200 may be executed at a cloud server or servers (e.g., a public server). In some embodiments, the configurable data pipeline 200 may instead be executed at a server or servers remote from the client devices 106.

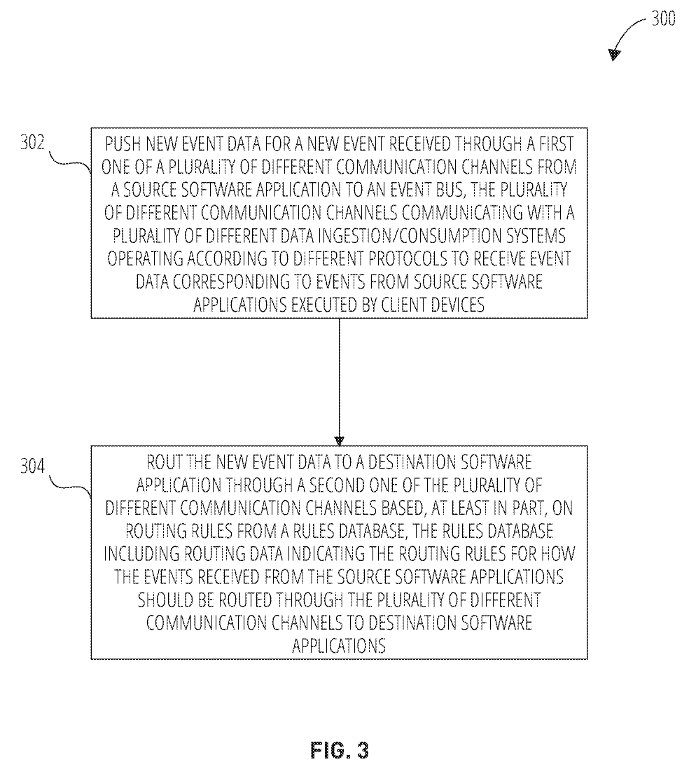

FIG. 3 is a flowchart illustrating a method 300 of operating a configurable data pipeline (e.g., the configurable data pipeline 200 of FIG. 1 and FIG. 2), according to some embodiments. At operation 302, the method 300 includes pushing new event data (e.g., the new event data 222 of FIG. 2) for a new event received through a first one of a plurality of different communication channels (e.g., the communication channels 208 of FIG. 2) from a source software application to an event bus (e.g., the event bus 230 of FIG. 2). The plurality of different communication channels communicate with a plurality of different data ingestion/consumption systems (e.g., the data ingestion/consumption systems 104 of FIG. 1) operating according to different protocols to receive event data (e.g., the event data 216) corresponding to events from source software applications (e.g., the source software applications 102 of FIG. 1) executed by client devices e.g., the client devices 106 of FIG. 1). In some embodiments, the plurality of different data ingestion systems include one or more of a real-time data streaming system (e.g., one or more of the real-time data streaming systems 116 of FIG. 1), a full-duplex communication channel over a persistent connection (e.g., one or more of the full-duplex communication channels 114 of FIG. 1), or a serverless computing system (e.g., one or more of the serverless computing systems 112 of FIG. 1).

At operation 304, the method 300 includes routing the new event data to a destination software application (e.g., to one or more of the destination software applications 132 of FIG. 1) through a second one of the plurality of different communication channels based, at least in part, on routing rules (e.g., the configurable rules 240 of FIG. 2) from a rules database. The rules database includes routing data indicating the routing rules for how the events received from the source software applications should be routed through the plurality of different communication channels to destination software applications. In some embodiments, routing the new event data (operation 304) to the destination software application includes filtering (e.g., using the filter and enrichment mechanisms 238) at least a sub-portion of the new event data from the new event data prior to routing the new event data to the destination software application. In some embodiments, routing the new event data (operation 304) to the destination software application includes adding supplemental information to the new event data (e.g., using the filter and enrichment mechanisms 238) prior to routing the new event data to the destination software application. In some embodiments, routing the new event data (operation 304) to the destination software application includes routing the new event data to the destination software application in real-time (e.g., according to the real-time subscription 234 of FIG. 2). In some embodiments, routing the new event data (operation 304) to the destination software application includes routing the new event data to the destination software application in a batch of the event data (e.g., according to the batch subscription 236 of FIG. 2).

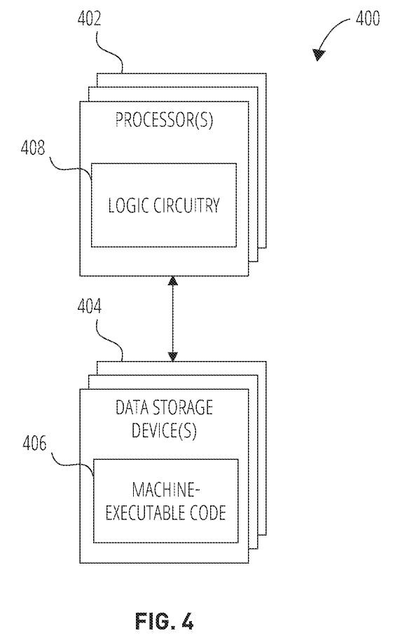

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 4 illustrates non-limiting examples of implementations of functional elements disclosed herein. In some embodiments, some or all portions of the functional elements disclosed herein may be performed by hardware specially configured for carrying out the functional elements.

FIG. 4 is a block diagram of circuitry 400 that, in some embodiments, may be used to implement various functions, operations, acts, processes, and/or methods disclosed herein. The circuitry 400 includes one or more processors 402 (sometimes referred to herein as “processors 402”) operably coupled to one or more data storage devices (sometimes referred to herein as “storage 404”). The storage 404 includes machine-executable code 406 stored thereon and the processors 402 include logic circuitry 408. The machine-executable code 406 includes information describing functional elements that may be implemented by (e.g., performed by) the logic circuitry 408. The logic circuitry 408 is adapted to implement (e.g., perform) the functional elements described by the machine-executable code 406. The circuitry 400, when executing the functional elements described by the machine-executable code 406, should be considered as special purpose hardware configured for carrying out functional elements disclosed herein. In some embodiments, the processors 402 may be configured to perform the functional elements described by the machine-executable code 406 sequentially, concurrently (e.g., on one or more different hardware platforms), or in one or more parallel process streams.

When implemented by logic circuitry 408 of the processors 402, the machine-executable code 406 is configured to adapt the processors 402 to perform operations of embodiments disclosed herein. For example, the machine-executable code 406 may be configured to adapt the processors 402 to perform at least a portion or a totality of the method 300 of FIG. 3. As another example, the machine-executable code 406 may be configured to adapt the processors 402 to perform at least a portion or a totality of the operations discussed for the configuration GUI 108 of FIG. 1, the application server 110 of FIG. 1, the source software applications 102 of FIG. 1, the data ingestion/consumption systems 104 of FIG. 1, the configurable data pipeline 200 of FIG. 1 and FIG. 2 (e.g., the communication channels 208, the event bus 230, the schema registry 232, the real-time subscription 234, the batch subscription 236, the rules logic 244, the filter and enrichment mechanisms 238, the configurable rules 240, the cache lookup 242) As a specific, non-limiting example, the machine-executable code 406 may be configured to adapt the processors 402 to push new event data for a new event received through a first one of a plurality of different communication channels from a source software application to an event bus. The plurality of different communication channels communicate with a plurality of different data ingestion/consumption systems operating according to different protocols to receive event data corresponding to events from source software applications executed by client devices. As another specific, non-limiting example, the machine-executable code 406 may be configured to adapt the processors 402 to route the new event data to a destination software application through a second one of the plurality of different communication channels based, at least in part, on routing rules from a rules database. The rules database includes routing data indicating the routing rules for how the events received from the software applications should be routed through the plurality of different communication channels to destination software applications. The data storage 404 may also include the rules database stored thereon, and the rules database may include the routing rules, filter rules and enrichment rules. In some embodiments, the routing rules include rules based on one or more of event type, event source (e.g., a source software application), or event content. In some embodiments, the machine-executable code 406 is further configured to instruct the processors 402 to support an application server configured to provide a web application to the client devices, the web application configured to enable users at the client devices to adjust rules stored by the rules database.

The processors 402 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 406 (e.g., software code, firmware code, hardware descriptions) related to embodiments of the present disclosure. It is noted that a general-purpose processor (may also be referred to herein as a host processor or simply a host) may be a microprocessor, but in the alternative, the processors 402 may include any conventional processor, controller, microcontroller, or state machine. The processors 402 may also be implemented as a combination of computing devices, such as a combination of a DSP and a microprocessor, a plurality of microprocessors, one or more microprocessors in conjunction with a DSP core, or any other such configuration.

In some embodiments, the storage 404 includes volatile data storage (e.g., random-access memory (RAM)), non-volatile data storage (e.g., Flash memory, a hard disc drive, a solid state drive, erasable programmable read-only memory (EPROM), etc.). In some embodiments, the processors 402 and the storage 404 may be implemented into a single device (e.g., a semiconductor device product, a system on chip (SOC), etc.). In some embodiments, the processors 402 and the storage 404 may be implemented into separate devices.

In some embodiments, the machine-executable code 406 may include computer-readable instructions (e.g., software code, firmware code). By way of non-limiting example, the computer-readable instructions may be stored by the storage 404, accessed directly by the processors 402, and executed by the processors 402 using at least the logic circuitry 408. Also by way of non-limiting example, the computer-readable instructions may be stored on the storage 404, transferred to a memory device (not shown) for execution, and executed by the processors 402 using at least the logic circuitry 408. Accordingly, in some embodiments, the logic circuitry 408 includes electrically configurable logic circuitry 408.

In some embodiments, the machine-executable code 406 may describe hardware (e.g., circuitry) to be implemented in the logic circuitry 408 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG^{TM}, SYSTEMVERILOG^{TM} or very large scale integration (VLSI) hardware description language (VHDL^{TM}) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 408 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments, the machine-executable code 406 may include an HDL, an RTL, a GL description, a mask level description, other hardware description, or any combination thereof.

In embodiments where the machine-executable code 406 includes a hardware description (at any level of abstraction), a system (not shown, but including the storage 404) may be configured to implement the hardware description described by the machine-executable code 406. By way of non-limiting example, the processors 402 may include a programmable logic device (e.g., an FPGA or a PLC) and the logic circuitry 408 may be electrically controlled to implement circuitry corresponding to the hardware description into the logic circuitry 408. Also by way of non-limiting example, the logic circuitry 408 may include hard-wired logic manufactured by a manufacturing system (not shown, but including the storage 404) according to the hardware description of the machine-executable code 406.

Regardless of whether the machine-executable code 406 includes computer-readable instructions or a hardware description, the logic circuitry 408 is adapted to perform the functional elements described by the machine-executable code 406 when implementing the functional elements of the machine-executable code 406. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A configurable data pipeline, comprising:
one or more processors; and
one or more data storage devices operably coupled to the one or more processors, the one or more data storage devices having computer-readable instructions stored thereon, the computer-readable instructions configured to instruct the one or more processors to:
maintain a plurality of different communication channels to a plurality of different data ingestion/consumption systems operating according to different protocols to receive event data corresponding to events from source software applications executed by client devices and route the event data to destination software applications executed by the client devices;
maintain a rules database on the one or more data storage devices, the rules database including routing data indicating routing rules for how the events received from the source software applications should be routed through the plurality of different communication channels to the destination software applications;
push new event data for a new event received through a first one of the plurality of different communication channels from a source software application to an event bus; and
route the new event data to a destination software application through a second one of the plurality of different communication channels based, at least in part, on the routing rules from the rules database.

2. The configurable data pipeline of claim 1, wherein the plurality of different data ingestion/consumption systems include one or more real-time data streaming systems.

3. The configurable data pipeline of claim 1, wherein the plurality of different data ingestion/consumption systems include one or more full-duplex communication channels over a persistent connection.

4. The configurable data pipeline of claim 1, wherein the plurality of different data ingestion/consumption systems include one or more serverless computing systems.

5. The configurable data pipeline of claim 1, wherein the source software applications and the destination software applications executed by the client devices include vehicle dealership software applications.

6. The configurable data pipeline of claim 1, wherein the vehicle dealership software applications include one or more of customer relationship management software applications, inventory management software applications, finance and insurance software applications, document management software applications, or customer-facing retail platform software applications.

7. The configurable data pipeline of claim 1, wherein the routing rules specify modes of routing event data to destination software applications, the modes of routing configurable by users of the client devices.

8. The configurable data pipeline of claim 7, wherein the modes of routing include real-time routing and batch routing.

9. The configurable data pipeline of claim 1, wherein:
the rules database also includes filter rules specifying sub-portions of received event data that are to be routed; and
the computer-readable instructions are further configured to instruct the one or more processors to route the new event data based, at least in part, on the filter rules.

10. The configurable data pipeline of claim 1, wherein:
the rules database further includes enrichment rules specifying supplemental information to be routed to the destination databases with the event data; and
the computer-readable instructions are further configured to instruct the one or more processors to route the new event data based, at least in part, on the enrichment rules.

11. A method of operating a configurable data pipeline, the method comprising:
pushing new event data for a new event received through a first one of a plurality of different communication channels from a source software application to an event bus, the plurality of different communication channels communicating with a plurality of different data ingestion/consumption systems operating according to different protocols to receive event data corresponding to events from source software applications executed by client devices; and
routing the new event data to a destination software application through a second one of the plurality of different communication channels based, at least in part, on routing rules from a rules database, the rules database including routing data indicating the routing rules for how the events received from the source software applications should be routed through the plurality of different communication channels to destination software applications.

12. The method of claim 11, wherein routing the new event data to the destination software application comprises filtering at least a sub-portion of the new event data from the new event data prior to routing the new event data to the destination software application.

13. The method of claim 11, wherein routing the new event data to the destination software application comprises adding supplemental information to the new event data prior to routing the new event data to the destination software application.

14. The method of claim 11, wherein routing the new event data to the destination software application comprises routing the new event data to the destination software application in real-time.

15. The method of claim 11, wherein routing the new event data to the destination software application comprises routing the new event data to the destination software application in a batch of the event data.

16. The method of claim 11, wherein the plurality of different data ingestion/consumption systems include one or more of a real-time data streaming system, a full-duplex communication channel over a persistent connection, or a serverless computing system.

17. One or more computer-readable media including computer-readable instructions stored thereon, the computer-readable instructions configured to instruct one or more processors to:
push new event data for a new event received through a first one of a plurality of different communication channels from a source software application to an event bus, the plurality of different communication channels communicating with a plurality of different data ingestion/consumption systems operating according to different protocols to receive event data corresponding to events from source software applications executed by client devices; and
route the new event data to a destination software application through a second one of the plurality of different communication channels based, at least in part, on routing rules from a rules database, the rules database including routing data indicating the routing rules for how the events received from the software applications should be routed through the plurality of different communication channels to destination software applications.

18. The one or more computer-readable media of claim 17, wherein:
the one or more computer-readable media also includes the rules database stored thereon; and
the rules database includes the routing rules, filter rules, and enrichment rules.

19. The one or more computer-readable media of claim 17, wherein the computer-readable instructions are further configured to instruct the one or more processors to support an application server configured to provide a web application to the client devices, the web application configured to enable users at the client devices to adjust rules stored by the rules database.

20. The one or more computer-readable media of claim 17, wherein the routing rules include rules based on one or more of event type, event source, or event content.
